(19) United States
(12) Patent Application Publication
(10) Pub. No.: US 2004/0130623 A1
(43) Pub. Date: Jul. 8, 2004

(54) Point-of sale (POS) system with built-in digital video recorder (DVR) and data handling method thereof

(76) Inventor: Hyun Tack Han, Gyeonggi-do (KR)

Correspondence Address: HARNESS, DICKEY & PIERCE, P.L.C., P.O. BOX 828, BLOOMFIELD HILLS, MI, 48303, US

(21) Appl. No.: 10/704,017

(22) Filed: Nov. 7, 2003

(30) Foreign Application Priority Data
Nov. 28, 2002 (KR) 2002-74789

(51) Int. Cl. H04N 7/18

(52) U.S. Cl. 348/150; 348/143

(57) ABSTRACT

The present invention relates to a point-of-sale (POS) system with built-in digital video recorder (DVR) and data handling method thereof. In more detail, it relates to a system that integrates the functions of POS management system and DVR system.

The present invention presents a POS system comprising POS input means, a POS main body, and POS output means, that collects and records the sales-management data accompanied with the sale of merchandise automatically at the point of sale, characterized by further comprising numbers of monitoring cameras and a DVR capture board to accomplish that the sales data inputted through the POS input means and the captured moving picture data are being processed by the control section of the POS main body so that the sales-data and the moving pictures are displayed together on a monitor screen.

### BACKGROUND OF THE INVENTION

1. Field of the Invention

The present invention relates to a point-of-sale (POS) system with built-in digital video recorder (DVR) and data handling method thereof. In more detail, it relates to a system that integrates the functions of point-of-sale management system and digital video recording system.

2. Description of the Related Art

A POS system, representing a point-of-sale management system, is a system that enables an overall management on marketing business such as sales-work, market research, stock-taking, POS management, etc. by installing a POS terminal at a shop.

In other words, the system collects and records the sales-management data (data required for sales-management and/or stock-taking of the merchandise) accompanied with the sale of the merchandise automatically at the point of sale by using a POS terminal, having the functions of an electronic cash register and a computer, installed at the counter of a department store or a supermarket.

The main role of a prior cash register is to calculate the total price of the merchandise for a customer immediately and accurately. In addition to carry out the function of a prior cash register, a current POS system collects and manipulates the purchase/sale information on the merchandise so that it enables an immediate checking and management on various merchandise information and/or accounting information by using the manipulated information.

In addition to the same function of a prior cash register, a POS terminal has the functions of temporary recording of data, communicating with higher level system, and transmitting the POS data to the higher level system. It reads the merchandise codes by key-input or scanner-input and transmits them to the higher level system.

On the other hand, a digital video recording (DVR) system is a next-generation CCTV (Closed Circuit Television) video recording system that converts the video signals inputted from a CCD (Charge-Coupled Device) camera-a monitoring camera into digital signals and records the digital signals into a recording device. It is an integrated system comprising a frame switch, a screen divider, a time lapse VCR, etc., each of which should be separately purchased in an analog system.

A CCTV is a television system in which the video signals are transmitted only to the specific receivers. The transmission/reception can be achieved by wired/wireless communication and an arbitrary person except the pre-determined receivers can not receive the signal.

Different from a conventional analog VCR, a DVR system described above has the following advantages: it does not need a periodic maintenance like an exchange/storage of a videotape; there is no quality degradation of video image due to the repetitive use of a videotape; and it can provide a fast search without a tape exchange when required.

In the prior art, a POS system and a DVR system have been installed and operated separately, and thus the installation and operation mechanism have been complicated. Furthermore, numbers of CCTV screens installed for burglary-watch have been being monitored integrally at a monitoring room or a management office, and thus it could cause a difficulty for a monitoring person to do his job effectively.

Besides, in the prior art, the screen of POS system displays the contents required for sales-calculation and the CCTV screen in monitoring room displays the contents for burglary-watch respectively. Thus, a user can not monitor the shop for burglary-watch while he (or she) is selling the merchandise at counter.

### SUMMARY OF THE INVENTION

The present invention is proposed to solve the problems of the prior art mentioned above. It is therefore the object of the present invention to provide a point-of-sale (POS) system with built-in digital video recorder (DVR), that integrates the functions of POS system and DVR system and thereby enables a user to carry out sales-work and burglary-watch at the same time by displaying the moving pictures photographed by CCTV of DVR on the screen used for sales-work of POS system, and data handling method thereof.

To achieve the object mentioned above, the present invention provides a point-of-sale (POS) system with built-in digital video recorder (DVR), wherein the POS system comprises POS input means for inputting sales-data, a POS main body, and POS output means for outputting the sales-data on monitor screen and thereby collects and records the sales-management data accompanied with the sale of merchandise automatically at the point of sale, characterized in that: the POS system further comprises numbers of monitoring cameras for monitoring the movements of the subjects and a DVR capture board for capturing the moving pictures photographed by the monitoring cameras, converting them into digital signals and transferring the signals to the POS main body; and thereby the sales-data inputted through the POS input means and the captured moving picture data are being processed by the control section of the POS main body so that the sales-data and the moving pictures are being outputted together on a monitor screen.

To achieve the object mentioned above, the present invention also provides a data handling method of point-of-sale (POS) system with built-in digital video recorder (DVR), wherein the POS system comprises POS input means for inputting sales-data, a POS main body, POS output means for outputting the sales-data on monitor screen, and a DVR capture board for capturing the moving pictures photographed by monitoring cameras and transferring them to the POS main body, characterized by comprising the steps of: when POS program starts running, the control section of the POS main body checking that moving picture data is being inputted through the DVR capture board to confirm that the monitoring cameras are being operated; if the monitoring cameras are being operated, the control section checking that inputs, such as some characters or the like, are being inputted through the POS input means to confirm that sales-data is being inputted; if sales-data is being inputted, the control section capturing the moving pictures from the monitoring cameras into the DVR capture board; the control section receiving the captured moving picture data and the inputted sales-data as input and storing them into a hard disk driver (HDD) of the POS main body; and the control section outputting the captured moving picture data and the inputted sales-data together on a monitor screen.

### BRIEF DESCRIPTION OF THE DRAWINGS

FIG. 1 is a structural diagram illustrating the point-of-sale (POS) system in accordance with the present invention.

FIG. 2 is a flowchart illustrating the data handling method of the point-of-sale (POS) system in accordance with the present invention.

FIG. 3 is a flowchart illustrating the data handling method described in FIG. 2 in case of sales-data being outputted alone.

FIG. 4 is a flowchart illustrating the data handling method described in FIG. 2 in case of moving picture data being outputted alone.

### DESCRIPTION OF THE NUMERALS ON THE MAIN PARTS OF THE DRAWINGS

10: a control section

20: a monitoring camera

30: a DVR capture board

40: a VGA card

50: a monitor

62: a keyboard

64: a card reader

66: a scanner

72: a hard disk driver (HDD)

74: a memory

76: a CPU

82: Internet

84: a main server

86: a modem

88: a value-added network (VAN)

90: a printer

### DETAILED DESCRIPTION OF THE EMBODIMENTS

Hereinafter, referring to appended drawings, the structures and operation principles of the embodiments of the present invention are described in detail.

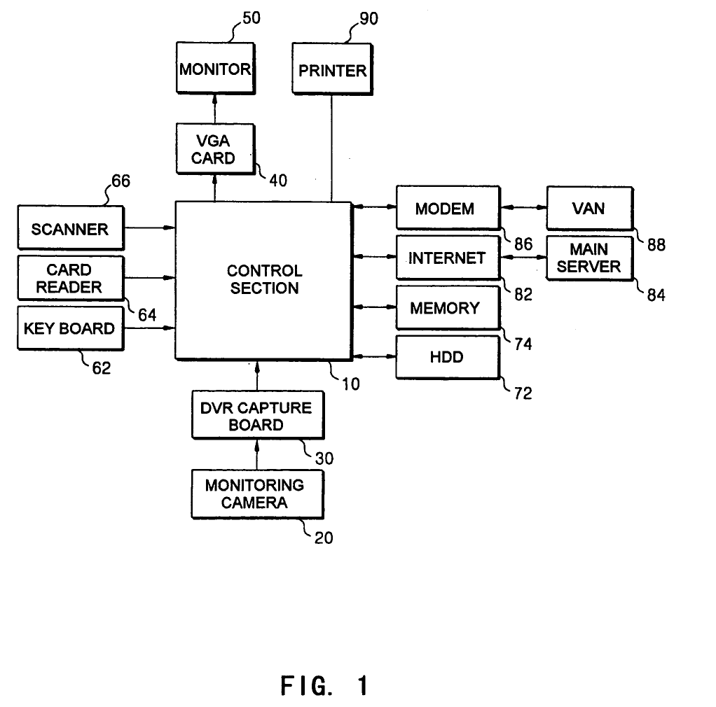

FIG. 1 is a structural diagram illustrating the point-of-sale (POS) system in accordance with the present invention.

POS input means comprises a keyboard (62) composed of category keys for inputting the merchandise information-related input data and number keys for inputting the price of the merchandise, a card reader (64) for reading credit card information for the case of a credit card being used for settlement, and a scanner (66) for reading bar-codes to input the price and the information of merchandise.

In addition, a mouse can also be included into the POS input means.

As the input means of DVR, numbers of monitoring cameras (20) are installed to watch over the shop. The moving pictures photographed by the monitoring cameras (20) are captured into DVR capture board (30) and converted into digital signals therein.

A POS main body comprises a control section (10), a memory (74), and a hard disk driver (HDD; 72). The control section (10) handles the sales-data inputted through the POS input means and the moving picture data inputted through the monitoring cameras (20) and controls overall system for data processing.

The captured moving picture data and the inputted sales-data are being stored into the HDD (72) and transmitted to the central main server (84) through external Internet (82) like a local area network (LAN).

The memory (74) contains font information or the like for displaying the characters inputted through the POS input means on the monitor screen.

The sales-data and the moving picture data are inputted into the control section (10) and displayed together on the monitor (50) as video output through a VGA card (40) by the control of the control section (10)

A printer (90) is equipped to output the list of shopped merchandise for a customer and/or, in the case of credit card being used, to output the card information read by a card reader (64) and the settlement price on a paper.

As described above, POS output means comprises a VGA card (40), a monitor (50), and a printer (90).

In addition, for the case of credit card being used, a modem (86) can be equipped for connecting to the value-added network (VAN; 88) to obtain an approval of the credit card.

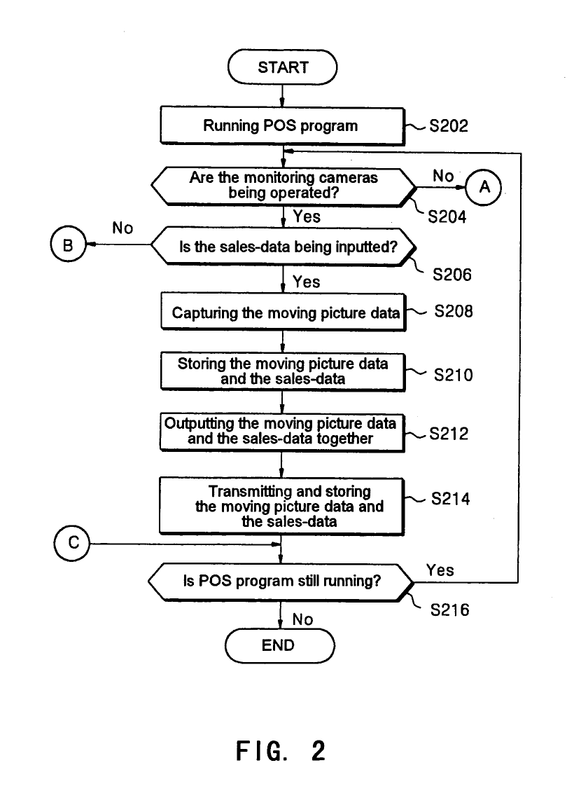

FIG. 2 is a flowchart illustrating the data handling method of the point-of-sale (POS) system in accordance with the present invention.

The present invention is derived with the purpose of displaying the moving picture data photographed by monitoring cameras together with the sales-data on the monitor of POS system.

According to the present invention, a POS program is being started when the system is turned ‘ON’ (S202).

When POS program is being started, the control section (10) checks that moving picture data is being inputted through the DVR capture board (30) to confirm that the monitoring cameras (20) are being operated (S204).

If the monitoring cameras (20) are being operated, the control section (10) checks that inputs, such as some characters or the like, are being inputted through the POS input means, such as a scanner (66) for reading bar-codes and/or a keyboard (62) for direct character input, to confirm that sales-data is being inputted (S206).

If sales-data is being inputted, the control section (10) controls the DVR capture board (30) to capture the moving pictures, being photographed by the monitoring cameras (20) installed inside the shop, thereinto (S208).

The control section (10) receives the captured moving picture data and the inputted sales-data as input and stores them into a hard disk driver (HDD; 72) so that these data can be outputted together with being linked to each other (S210).

Then, the control section (10) controls the VGA card (40) for the captured digital moving picture data and the inputted sales-data to be outputted together on a monitor (50) screen (S212).

In addition, the control section (10) transmits the sales-data and the moving picture data stored in the HDD (72) to the central main server (84) through Internet (82), and the main server stores and manages the data transmitted from numbers of POS systems of various shops and monitors the insides of the shops using the transmitted moving picture data (S214).

The control section (10) is then checking that POS program is still running (S216), and repeats the above-described steps if the program is still running. If the program is not running, the control section (10) terminates the procedure.

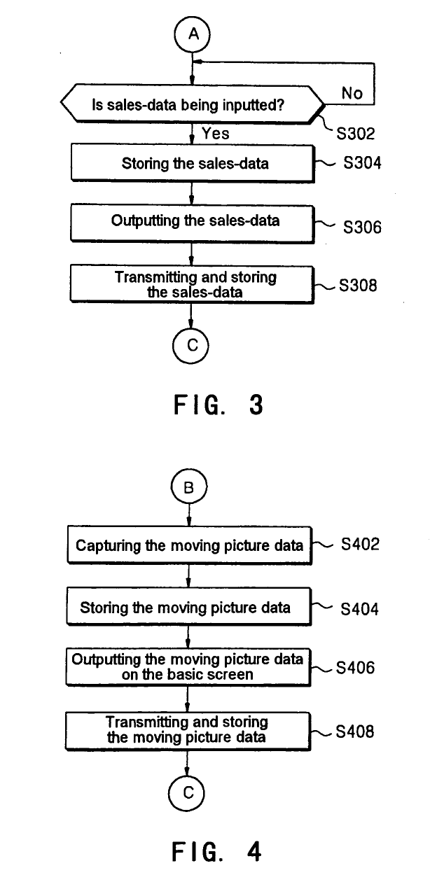

FIG. 3 is a flowchart illustrating the data handling method described in FIG. 2 in case of sales-data being outputted alone. In other words, it shows the procedures if the monitoring cameras are not being operated at the pre-described step of S204.

If the monitoring cameras (20) are not being operated, the control section (10) checks that inputs, such as some characters or the like, are being inputted through the POS input means, such as a scanner (66) for reading bar-codes and/or a keyboard (62) for direct character input, to confirm that sales-data is being inputted (S302).

If sales-data is being inputted, the control section (10) receives the inputted sales-data as input and stores the data into the HDD (72) (S304).

Then, the control section (10) controls the VGA card (40) for the inputted sales-data to be outputted alone on a monitor (50) screen like in the conventional POS system (S306).

In addition, the control section (10) transmits the sales-data stored in the HDD (72) to the central main server (84) through Internet (82), and the main server (84) stores and manages the data transmitted from numbers of POS systems of various shops (S308).

Then, the system carries out the step of S216 described in FIG. 2.

FIG. 4 is a flowchart illustrating the data handling method described in FIG. 2 in case of moving picture data being outputted alone. It shows the procedures if the sales-data is not being inputted at the pre-described step of S206, that is, only the monitoring cameras (20) are being operated.

If sales-data is not being inputted, the control section (10) controls the DVR capture board (30) to capture the moving pictures, being photographed by the monitoring cameras (20) installed inside the shop, thereinto (S402).

The control section (10) receives the captured moving picture data as input and stores the data into the HDD (72) (S404).

Then, the control section (10) controls the VGA card (40) for the captured moving picture data to be outputted on the basic screen of the monitor (S406).

Here, a basic screen means a screen of conventional POS system in the case of no sales-data output.

In addition, the control section (10) transmits the moving picture data stored in the HDD (72) to the central main server (84) through Internet (82), and the main server stores and manages the data transmitted from numbers of POS systems of various shops and monitors the insides of the shops using the transmitted moving picture data (S408).

Then, the system carries out the step of S216 described in FIG. 2.

Since the moving picture data stored in the main server (84) can be monitored through a web-homepage and/or a cellular phone, the present invention can be used as a remote burglary-watch system with using the stored moving picture data.

As described thereinbefore, a POS system of the present invention can store digitized moving picture into HDD (72) using DVR capture board (30) and display the stored moving picture together with the sales-data on the monitor screen.

That is to say, by simply connecting the pre-installed monitoring cameras (20) to a DVR capture board (30) internally installed at a POS system being operated in a shop and thereby displaying the moving picture data of each monitoring camera (20) on the monitor screen of the corresponding POS system, the present invention increases the management efficiency by enabling a clerk to watch over the shop while he (or she) is doing the sales-work.

In addition, since a POS system and a DVR are integrated into a single system in the present invention, the installation as well as the operation of the system is very simple. Besides, the images from the monitoring cameras (20) can be double-watched by a salesclerk and a guard at the same time for preventing a shop-lift.

As mentioned thereinbefore, a POS system in accordance with the present invention integrates the functions of POS system and DVR system into a single system, and thus it enables a user to carry out sales-work and burglary-watch at the same time by displaying the moving pictures photographed by CCTV of DVR on the screen used for sales-work of POS system.

Since those having ordinary knowledge and skill in the art of the present invention will recognize additional modifications and applications within the scope thereof, the present invention is not limited to the embodiments and drawings described above.

What is claimed is:

1. A point-of-sale (POS) system with built-in digital video recorder (DVR),
wherein said POS system comprises POS input means for inputting sales-data, a POS main body, and POS output means for outputting the sales-data on a monitor screen and thereby collects and records the sales-management data accompanied with the sale of merchandise automatically at the point of sale,
characterized in that said POS system further comprises numbers of monitoring cameras for monitoring the movements of the subjects and a DVR capture board for capturing the moving pictures photographed by said monitoring cameras, converting them into digital signals and transferring said signals to said POS main body; and said sales-data inputted through said POS input means and said captured moving picture data are being processed by the control section of said POS main body so that said sales-data and said moving pictures are outputted together on a monitor screen.

2. A point-of-sale (POS) system with built-in digital video recorder (DVR) as claimed in claim 1,
characterized in that said sales-data and said moving picture data are being stored into a hard disk driver (HDD) of said POS main body so that these data can be outputted together with being linked to each other.

3. A point-of-sale (POS) system with built-in digital video recorder (DVR) as claimed in claim 2,
characterized in that said sales-data and said moving picture data stored in said HDD are being transmitted to a main server through external Internet, and said main server stores and manages said sales-data and said moving picture data transmitted from numbers of POS systems and monitors the shop using said moving picture data.

4. A data handling method of a point-of-sale (POS) system with built-in digital video recorder (DVR),
wherein said POS system comprises POS input means for inputting sales-data, a POS main body, POS output means for outputting the sales-data on a monitor screen, and a DVR capture board for capturing the moving pictures photographed by monitoring cameras and transferring them to said POS main body,
characterized by comprising the steps of:
when POS program starts running, the control section of said POS main body checking that moving picture data is being inputted through said DVR capture board to confirm that said monitoring cameras are being operated;
if said monitoring cameras are being operated, said control section checking that inputs, such as some characters or the like, are being inputted through said POS input means to confirm that sales-data is being inputted;
if sales-data is being inputted, said DVR capture board capturing said moving pictures from said monitoring cameras by the control of said control section;
said control section receiving said captured moving picture data and said inputted sales-data as input and storing them into a hard disk driver (HDD) of said POS main body; and
said control section outputting said captured moving picture data together with said inputted sales-data on a monitor screen.

5. A data handling method of a point-of-sale (POS) system with built-in digital video recorder (DVR) as claimed in claim 4,
characterized in that, if said monitoring cameras are not being operated, said method carries out the steps of:
said control section checking that inputs, such as some characters or the like, are being inputted through said POS input means to confirm that sales-data is being inputted;
if sales-data is being inputted, said control section receiving said inputted sales-data as input and storing said sales-data into a hard disk driver (HDD) of said POS main body; and
said control section outputting said inputted sales-data on a monitor screen.

6. A data handling method of a point-of-sale (POS) system with built-in digital video recorder (DVR) as claimed in claim 4,
characterized in that, if said sales-data is not being inputted, said method carries out the steps of:
said DVR capture board capturing said moving pictures from said monitoring cameras by the control of said control section;
said control section receiving said captured moving picture data as input and storing said captured moving picture data into a hard disk driver (HDD) of said POS main body; and
said control section outputting said captured moving picture data on a basic screen of said monitor.
